(19) United States
(12) Patent Application Publication
(10) Pub. No.: US 2016/0350498 A1
(43) Pub. Date: Dec. 1, 2016

(54) FRAUD DETECTION BASED ON ASSESSMENT OF PHYSICIANS' ACTIVITY

(71) Applicant: International Business Machines Corporation, Armonk, NY (US)

(72) Inventors: Sharbell Hashoul, Haifa (IL); Pavel Kisilev, Maalot (IL); Eugene Walach, Haifa (IL); Aviad Zlotnick, Mitzpe Netofah (IL)

(21) Appl. No.: 14/722,165

(22) Filed: May 27, 2015

(51) Int. Cl. G06F 19/00

(52) U.S. Cl. CPC G06F 19/327; G06F 19/321

(57) ABSTRACT

A computer-implemented method, computerized apparatus and computer program product for detecting fraud based on assessment of phyisicians' activity. An automatic diagnostic tool is applied to a benchmark of cases of a physician to diagnose whether a predetermined procedure is required. A discrepancy relation is determined by comparing the percentage of cases in the benchmark the tool diagnosed as requiring the procedure with an expected percentage determined based on the percentage of cases diagnosed by the physician as requiring the procedure and the tool's accuracy. An alert is provided to a supervising entity responsive to a discrepancy indicated by the discrepancy relation.

### TECHNICAL FIELD

The present disclosure relates to statistical analysis in general, and to fraud detection based on assessment of physicians' activity, in particular.

### BACKGROUND

In recent years, the healthcare industry in several developed countries such as the United States has witnessed a paradigm shift in its underlying business models. In the past, healthcare providers acted merely as vendors selling various medical services, while responsibility for the funding and payment structure was bore by insurers, whether private or public. In this mode of operation, healthcare providers lacked an incentive to reduce costs of healthcare by, for example, avoiding some costly procedures not necessarily required. Nowadays, however, there is a noticeable ongoing switch to a model in which healthcare providers assume total and overall responsibility for certain populations, which includes the provision of medical services as well as the financing thereof. In the latter mode of operation, healthcare providers are bound to be interested in cost reduction of healthcare.

With healthcare costs being ever on the rise, there is a pressing need to streamline healthcare operations in order to minimize expenditure on the one hand, while maintaining quality of care and not inducing a concomitant increase in health risks on the other hand. Similar concerns may arise in connection with a possibility of healthcare personnel committing fraud by reporting bogus expenditures allegedly incurred in connection with healthcare services rendered.

### BRIEF SUMMARY

One exemplary embodiment of the disclosed subject matter is a computer-implemented method comprising: obtaining a benchmark of cases of one or more healthcare professionals, wherein each case is associated with a patient, wherein the one or more healthcare professionals diagnosed each of which cases to determine whether a procedure is required; determining a percentage T_{actual} of cases in the benchmark diagnosed by the one or more healthcare professionals as requiring the procedure; determining a percentage T_{expected} of cases in the benchmark expected to be diagnosed by a reference diagnostic tool as requiring the procedure, wherein the reference diagnostic tool is configured to automatically determine whether the procedure is required, wherein the reference diagnostic tool has a probability Pₚₒₛᵢₜᵢᵥₑ of correctly diagnosing that the procedure is required, wherein the reference diagnostic tool has a probability P_{negative} of correctly diagnosing that the procedure is not required, wherein the percentage T_{expected} is determined based on Pₚₒₛᵢₜᵢᵥₑ, P_{negative}, and T_{actual}; utilizing the reference diagnostic tool to automatically diagnose for each case of the benchmark whether the procedure is required; determining a percentage Tₐᵤₜₒ of cases in the benchmark diagnosed by the reference diagnostic tool as requiring the procedure; determining a discrepancy relation between T_{expected} and Tₐᵤₜₒ; and, in response to the discrepancy relation indicating a discrepancy, providing an alert to an entity supervising the one or more healthcare professionals.

Another exemplary embodiment of the disclosed subject matter is computerized apparatus having a processor, the processor being adapted to perform the steps of: obtaining a benchmark of cases of one or more healthcare professionals, wherein each case is associated with a patient, wherein the one or more healthcare professionals diagnosed each of which cases to determine whether a procedure is required; determining a percentage T_{actual} of cases in the benchmark diagnosed by the one or more healthcare professionals as requiring the procedure; determining a percentage T_{expected} of cases in the benchmark expected to be diagnosed by a reference diagnostic tool as requiring the procedure, wherein the reference diagnostic tool is configured to automatically determine whether the procedure is required, wherein the reference diagnostic tool has a probability Pₚₒₛᵢₜᵢᵥₑ of correctly diagnosing that the procedure is required, wherein the reference diagnostic tool has a probability P_{negative} of correctly diagnosing that the procedure is not required, wherein the percentage T_{expected} is determined based on Pₚₒₛᵢₜᵢᵥₑ, P_{negative}, and T_{actual}; utilizing the reference diagnostic tool to automatically diagnose for each case of the benchmark whether the procedure is required; determining a percentage Tₐᵤₜₒ of cases in the benchmark diagnosed by the reference diagnostic tool as requiring the procedure; determining a discrepancy relation between T_{expected} and Tₐᵤₜₒ; and, in response to the discrepancy relation indicating a discrepancy, providing an alert to an entity supervising the one or more healthcare professionals.

Yet another exemplary embodiment of the disclosed subject matter is a computer program product comprising a computer readable storage medium retaining program instructions, which program instructions when read by a processor, cause the processor to perform a method comprising: obtaining a benchmark of cases of one or more healthcare professionals, wherein each case is associated with a patient, wherein the one or more healthcare professionals diagnosed each of which cases to determine whether a procedure is required; determining a percentage T_{actual} of cases in the benchmark diagnosed by the one or more healthcare professionals as requiring the procedure; determining a percentage T_{expected} of cases in the benchmark expected to be diagnosed by a reference diagnostic tool as requiring the procedure, wherein the reference diagnostic tool is configured to automatically determine whether the procedure is required, wherein the reference diagnostic tool has a probability Pₚₒₛᵢₜᵢᵥₑ of correctly diagnosing that the procedure is required, wherein the reference diagnostic tool has a probability P_{negative} of correctly diagnosing that the procedure is not required, wherein the percentage T_{expected} is determined based on Pₚₒₛᵢₜᵢᵥₑ, P_{negative}, and T_{actual}; utilizing the reference diagnostic tool to automatically diagnose for each case of the benchmark whether the procedure is required; determining a percentage Tₐᵤₜₒ of cases in the benchmark diagnosed by the reference diagnostic tool as requiring the procedure; determining a discrepancy relation between T_{expected} and Tₐᵤₜₒ; and, in response to the discrepancy relation indicating a discrepancy, providing an alert to an entity supervising the one or more healthcare professionals.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows a block diagram of an apparatus, in accordance with some exemplary embodiments of the disclosed subject matter.

### DETAILED DESCRIPTION

One technical problem dealt with by the disclosed subject matter is to provide an assessment of physicians' performance with regard to diagnostic determinations, such as decisions of whether or not to perform a predetermined medical procedure. Such assessment may be used for detection of fraudulent activity. For example a finding of over-prescription of a costly procedure, such as a biopsy test, may indicate fraud, as a portion of the prescribed tests was unwarranted.

Another technical problem dealt with by the disclosed subject matter is to monitor for potential fraud without having physicians manually review cases.

One technical solution is to determine, for a given physician's population of patients, an expected percentage of cases which an automatic diagnostic tool would diagnose as requiring a predetermined medical procedure, based on a percentage of cases diagnosed by the physician as requiring the predetermined medical procedure, and to compare the percentage of cases diagnosed by the automatic diagnostic tool as requiring the predetermined medical procedure with the expected percentage. An automatic diagnostic tool may not be accurate and may have both false positive recommendations and false negative recommendations. Such potential erroneous recommendations may be taken into account by the disclosed subject matter. Discrepancies may be reviewed for potential fraudulent activity.

One technical effect of utilizing the disclosed subject matter is to accommodate for particular statistical characteristics of patient populations among different physicians, whereby overcoming limitations of conventional statistical averaging approaches. For example, a measurement of the average number of patients in the general population for which a predetermined medical procedure is being prescribed, may not be relevant to a particular patient population of a certain physician, either due to fluctuations in patient populations or because the size of such patient population may be too small in terms of random sampling. For example, if the expectation is of prescribing a medical procedure or treatment for 10% of the patients, a doctor having 2% prescription rate may still be over-prescribing the procedure, as his sub-population may be less prone to the underlying medical disease.

Another technical effect of utilizing the disclosed subject matter is to provide an alert on suspected fraud to an entity supervising a physician's activity, while using an imprecise reference for assessment of the physician's performance. In accordance with the disclosed subject matter, the physician's performance is compared to the imprecise reference, and a statistical analysis taking the imprecision into account is employed, whereby reliable statistical inferences for a given patient population of the physician are provided. The reference may be generated by applying an automatic diagnostic tool to evaluate all cases handled by the given physician. It will be noted that the automatic diagnostic tool may independently provide a proposed evaluation of each case. In some cases, the automatic diagnostic tool may base its evaluation on existing cases, such as by using data mining techniques. For example, the system may mine a large collection of clinical cases, find cases that are similar to the ones in question, and examine their outcomes to be used as a reference.

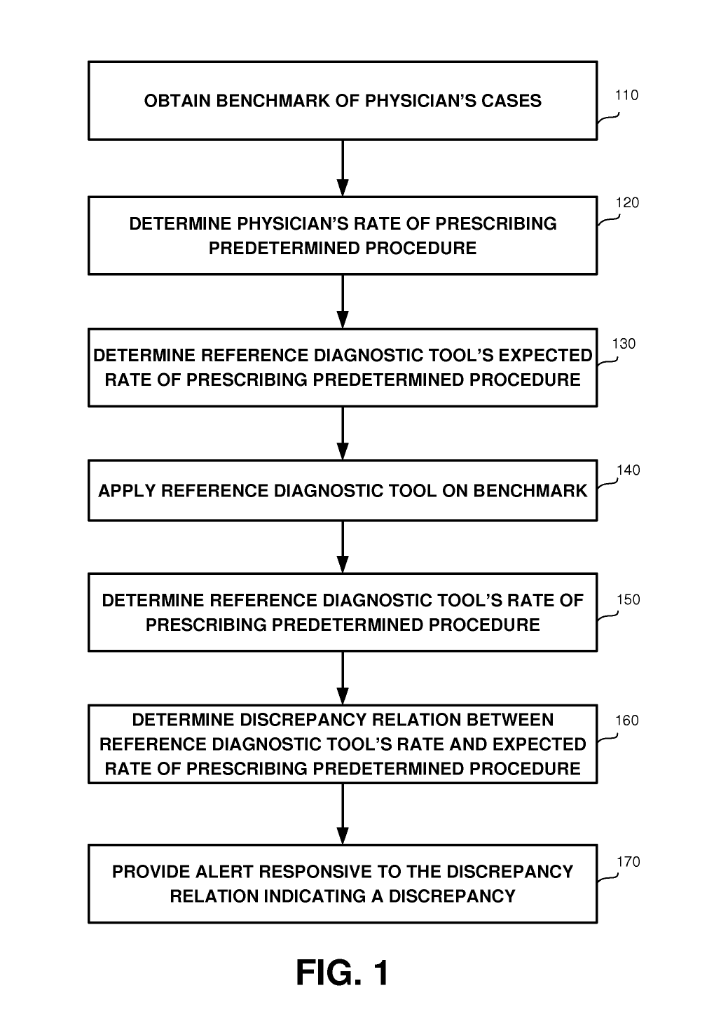

Referring now to FIG. 1 showing a flowchart diagram of a method in accordance with some exemplary embodiments of the disclosed subject matter.

On Step 110, a benchmark of cases of a physician may be obtained. The benchmark may comprise a population of patients of the physician for which the physician had determined whether or not a predetermined medical procedure is required. The benchmark may include information regarding each case, such as but not limited to clinical information, diagnostic imaging, lab test results, results of past procedures, medical history, or the like. In some exemplary embodiments, a case may include the prescription prescribed by the physician.

On Step 120, a percentage T_{actual} of cases diagnosed by the physician as requiring that the predetermined medical procedure be performed may be determined for the benchmark. T_{actual} may be computed by dividing the number of cases in which the physician prescribed the medical procedure by the total number of cases.

On Step 130, a percentage T_{expected} of cases in the benchmark expected to be diagnosed by an automatic diagnostic tool, also referred to as a reference diagnostic tool, as requiring that the predetermined medical procedure be performed, given the percentage T_{actual} and accuracy parameters associated with the reference diagnostic tool, may be determined. The reference diagnostic tool may be configured to determine automatically whether the predetermined medical procedure is required to be performed. The accuracy parameters associated with the reference diagnostic tool may include estimated probabilities Pₚₒₛᵢₜᵢᵥₑ and P_{negative}, wherein Pₚₒₛᵢₜᵢᵥₑ is a probability of correctly diagnosing by the reference diagnostic tool that the predetermined medical procedure is required to be performed on a patient, and P_{negative} is the probability of correctly diagnosing by the reference diagnostic tool that the predetermined medical procedure is not required to be performed on a patient.

On Step 140, the reference diagnostic tool may be utilized to automatically diagnose for each case of the benchmark whether the predetermined medical procedure is required. In some exemplary embodiments, the reference diagnostic tool may be configured to process all data available to the physician. In some exemplary embodiments, the data may include diagnostic imaging, clinical information, lab test results, results of past procedures, medical history, combination thereof, or the like.

On Step 150, a percentage Tₐᵤₜₒ of cases of the benchmark diagnosed by the reference diagnostic tool as requiring the predetermined medical procedure may be determined Tₐᵤₜₒ may be computed by dividing the number of cases in which the reference diagnostic tool recommends prescribing the medical procedure by the total number of cases.

On Step 160, a discrepancy relation between the expected percentage T_{expected} and the percentage Tₐᵤₜₒ of cases diagnosed by the reference diagnostic tool as requiring the predetermined medical procedure may be determined.

In some exemplary embodiments, the reference diagnostic tool may be characterized as having a variance Vₚₒₛᵢₜᵢᵥₑ of the probability Pₚₒₛᵢₜᵢᵥₑ and a variance V_{negative} of the probability while employing the reference diagnostic tool on a P_{negative} benchmark having a size of the benchmark. The discrepancy relation may be determined based on Pₚₒₛᵢₜᵢᵥₑ, P_{negative}, Vₚₒₛᵢₜᵢᵥₑ and V_{negative}.

In some exemplary embodiments, determining the discrepancy relation may comprise determining an expected range of values around T_{expected} based on Pₚₒₛᵢₜᵢᵥₑ, P_{negative}, Vₚₒₛᵢₜᵢᵥₑ and V_{negative}. The discrepancy relation may indicate a discrepancy if Tₐᵤₜₒ is not within the expected range of values.

In some exemplary embodiments, the expected range may be determined by the minimum and maximum values of:

(Pₚₒₛᵢₜᵢᵥₑ±Vₚₒₛᵢₜᵢᵥₑ)*T_{actual}α(P_{negative}±V_{negative})*(1−T_{actual})

On Step 170, in response to the discrepancy relation indicating a discrepancy, an alert on suspected fraud may be provided to an entity supervising the physician's activity. In some exemplary embodiments, the alert may comprise a notification that a discrepancy was detected. In some further exemplary embodiments, the alert may comprise a notification on the degree of the discrepancy. The degree of the discrepancy may be determined by dividing the difference between T_{expected} and Tₐᵤₜₒ by the variance of the expected range.

In some exemplary embodiments, different physicians may be compared for their performance, using the discrepancy relation determined for each physician's benchmark. Additionally or alternatively, discrepancy relations determined for a number of top physicians may be used for calibration purposes, such as for evaluating or testing accuracy parameters of the reference diagnostic tool.

In some exemplary embodiments, responsive to an alert on suspected fraud received by the supervising entity, an individual inspection of each of the physician's cases may be performed. Additionally or alternatively, data from different cases may be cross-referenced. For example, diagnostic images may be automatically compared to detect duplicities, which may be a result of a doctor attempting to justify a costly procedure for a patient who does not require such procedure.

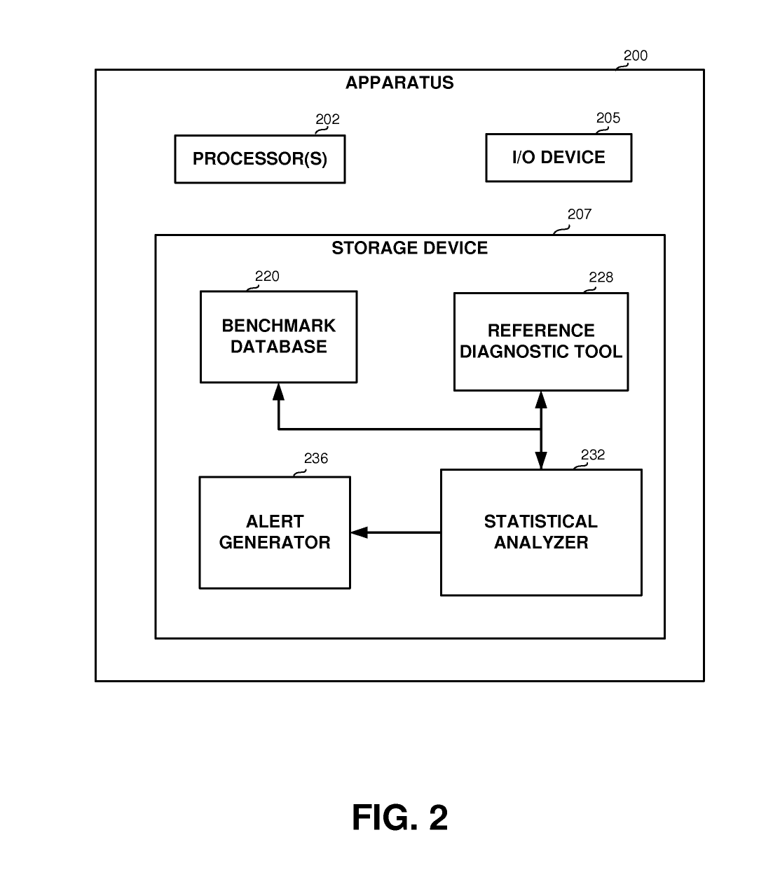

Referring now to FIG. 2 showing an apparatus in accordance with some exemplary embodiments of the disclosed subject matter. Apparatus 200 may be configured to provide for statistical assessment of physicians, in accordance with the disclosed subject matter.

In some exemplary embodiments, Apparatus 200 may comprise one or more Processor(s) 202. Processor 202 may be a Central Processing Unit (CPU), a microprocessor, an electronic circuit, an Integrated Circuit (IC) or the like. The processor 202 may be utilized to perform computations required by Apparatus 200 or any of it subcomponents.

In some exemplary embodiments of the disclosed subject matter, Apparatus 200 may comprise an Input/Output (I/O) module 205. I/O module 205 may be utilized to provide an output to and receive input from a user. Additionally or Alternatively, I/O module 205 may be utilized to provide an output to and receive input from another Apparatus 200 in communication therewith.

In some exemplary embodiments, Apparatus 200 may comprise a Storage Device 207. Storage Device 207 may be a hard disk drive, a Flash disk, a Random Access Memory (RAM), a memory chip, or the like. In some exemplary embodiments, Storage Device 207 may retain program code operative to cause Processor 202 to perform acts associated with any of the subcomponents of Apparatus 200.

Storage Device 207 may comprise a Benchmark Database 220 for receiving a benchmark of cases of a physician, which benchmark comprises population of patients of the physician, for each of which patients the physician had determined whether or not a predetermined medical procedure is required. The benchmark may be obtained via I/O module 205. In some exemplary embodiments, Benchmark Database 220 may include all data available to the physician. In some further exemplary embodiments, Benchmark Database 220 may include at least one of diagnostic imaging and clinical information.

Storage Device 207 may comprise a Reference Diagnostic Tool 228. Reference Diagnostic Tool 228 may be configured to determine automatically whether or not the predetermined medical procedure is required to be performed. In some further exemplary embodiments, Reference Diagnostic Tool 228 may be configured to process all data received at Benchmark Database 220.

Storage Device 207 may comprise a Statistical Analyzer 232, coupled to Benchmark Database 220 and Reference Diagnostic Tool 228. Statistical Analyzer 232 may be configured to determine for the benchmark received at Benchmark Database 220 a percentage T_{actual} of cases diagnosed by the physician as requiring that the predetermined medical procedure be performed. Statistical Analyzer 232 may be further configured to determine, based on the percentage T_{actual} and accuracy parameters associated with Reference Diagnostic Tool 228, a percentage T_{expected} of cases in the benchmark expected to be diagnosed by a reference diagnostic tool as requiring that the predetermined medical procedure be performed. The accuracy parameters associated with Reference Diagnostic Tool 228 may include estimated probabilities Pₚₒₛᵢₜᵢᵥₑ and P_{negative}, wherein Pₚₒₛᵢₜᵢᵥₑ is a probability of correctly diagnosing by the reference diagnostic tool that the predetermined medical procedure is required to be performed on a patient, and P_{negative} is the probability of correctly diagnosing by the reference diagnostic tool that the predetermined medical procedure is not required to be performed on a patient. The estimated probabilities Pₚₒₛᵢₜᵢᵥₑ and P_{negative} may be determined by Statistical Analyzer 232 or provided thereto in advance.

In some exemplary embodiments, Statistical Analyzer 232 may be configured to determine, for the benchmark at Benchmark Database 220, a percentage Tₐᵤₜₒ of cases of the benchmark diagnosed by Reference Diagnostic Tool 228 as requiring the predetermined medical procedure, when utilizing Reference Diagnostic Tool 228 to automatically diagnose for each case of the benchmark at Benchmark Database 220 whether the predetermined medical procedure is required. Statistical Analyzer 232 may be further configured to determine a discrepancy relation between T_{expected} and Tₐᵤₜₒ.

Storage Device 207 may comprise an Alert Generator 236 for providing an alert on suspected fraud to an entity supervising the physician. Alert Generator 236 may receive the discrepancy relation from Statistical Analyzer 232. Alert Generator 236 may be configured to provide alert in response to the discrepancy relation indicating a discrepancy.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
obtaining a benchmark of cases of one or more healthcare professionals, wherein each case is associated with a patient, wherein the one or more healthcare professionals diagnosed each of which cases to determine whether a procedure is required;
determining a percentage T_{actual} of cases in the benchmark diagnosed by the one or more healthcare professionals as requiring the procedure;
determining a percentage T_{expected} of cases in the benchmark expected to be diagnosed by a reference diagnostic tool as requiring the procedure, wherein the reference diagnostic tool is configured to automatically determine whether the procedure is required, wherein the reference diagnostic tool has a probability Pₚₒₛᵢₜᵢᵥₑ of correctly diagnosing that the procedure is required, wherein the reference diagnostic tool has a probability P_{negative} of correctly diagnosing that the procedure is not required, wherein the percentage T_{expected} is determined based on Pₚₒₛᵢₜᵢᵥₑ, P_{negative}, and T_{actual};
utilizing the reference diagnostic tool to automatically diagnose for each case of the benchmark whether the procedure is required;
determining a percentage Tₐᵤₜₒ of cases in the benchmark diagnosed by the reference diagnostic tool as requiring the procedure;
determining a discrepancy relation between T_{expected} and Tₐᵤₜₒ; and,
in response to the discrepancy relation indicating a discrepancy, providing an alert to an entity supervising the one or more healthcare professionals.

2. The computer-implemented method of claim 1,
wherein the reference diagnostic tool is characterized as having a variance Vₚₒₛᵢₜᵢᵥₑ of the probability Pₚₒₛᵢₜᵢᵥₑ while employing the reference diagnostic tool on Pₚₒₛᵢₜᵢᵥₑ a benchmark having a size of the benchmark;
wherein the reference diagnostic tool is characterized as having a variance V_{negative} the probability P_{negative} while employing the reference diagnostic tool on a benchmark having the size of the benchmark; and
wherein the discrepancy relation is determined based on Pₚₒₛᵢₜᵢᵥₑ, P_{negative}, Vₚₒₛᵢₜᵢᵥₑ and V_{negative}.

3. The computer-implemented method of claim 2, wherein said determining the discrepancy relation comprises: determining an expected range of values around T_{expected} based on Pₚₒₛᵢₜᵢᵥₑ, P_{negative}, Vₚₒₛᵢₜᵢᵥₑ and V_{negative}; and wherein the discrepancy relation indicates discrepancy if Tₐᵤₜₒ is not within the expected range of values.

4. The computer-implemented method of claim 3, wherein the expected range is a range between about (Pₚₒₛᵢₜᵢᵥₑ−Vₚₒₛᵢₜᵢᵥₑ)*T_{actual}+(P_{negative}−V_{negative})*(1−T_{actual}) and between about (Pₚₒₛᵢₜᵢᵥₑ+Vₚₒₛᵢₜᵢᵥₑ)*T_{actual}+(P_{negative}+V_{negative})*(1−T_{actual}).

5. The computer-implemented method of claim 1, wherein the reference diagnostic tool is configured to process all data available to the one or more healthcare professionals when performing said automatic determination.

6. The computer-implemented method of claim 5, wherein the data includes at least one of: diagnostic imaging; and clinical information.

7. The computer-implemented method of claim 1, further comprising performing an individual inspection of each of the cases in the benchmark.

8. The computer-implemented method of claim 7, further comprising cross-referencing data from different cases to detect duplicate information appearing in two or more cases.

9. The computer-implemented method of claim 8, wherein the duplicate information is a diagnostic image re-used for several patients.

10. A computerized apparatus having a processor, the processor being adapted to perform the steps of:
obtaining a benchmark of cases of one or more healthcare professionals, wherein each case is associated with a patient, wherein the one or more healthcare professionals diagnosed each of which cases to determine whether a procedure is required;
determining a percentage T_{actual} of cases in the benchmark diagnosed by the one or more healthcare professionals as requiring the procedure;
determining a percentage T_{expected} of cases in the benchmark expected to be diagnosed by a reference diagnostic tool as requiring the procedure, wherein the reference diagnostic tool is configured to automatically determine whether the procedure is required, wherein the reference diagnostic tool has a probability Pₚₒₛᵢₜᵢᵥₑ of correctly diagnosing that the procedure is required, wherein the reference diagnostic tool has a probability P_{negative} of correctly diagnosing that the procedure is not required, wherein the percentage T_{expected} is determined based on Pₚₒₛᵢₜᵢᵥₑ, P_{negative}, and T_{actual};
utilizing the reference diagnostic tool to automatically diagnose for each case of the benchmark whether the procedure is required;
determining a percentage Tₐᵤₜₒ of cases in the benchmark diagnosed by the reference diagnostic tool as requiring the procedure;
determining a discrepancy relation between T_{expected} and Tₐᵤₜₒ; and,
in response to the discrepancy relation indicating a discrepancy, providing an alert to an entity supervising the one or more healthcare professionals.

11. The computerized apparatus of claim 10,
wherein the reference diagnostic tool is characterized as having a variance Vₚₒₛᵢₜᵢᵥₑ of the probability Pₚₒₛᵢₜᵢᵥₑ while employing the reference diagnostic tool on a benchmark having a size of the benchmark;
wherein the reference diagnostic tool is characterized as having a variance V_{negative} of the probability P_{negative} while employing the reference diagnostic tool on a benchmark having the size of the benchmark; and
wherein the discrepancy relation is determined by the processor based on Pₚₒₛᵢₜᵢᵥₑ, P_{negative}, Vₚₒₛᵢₜᵢᵥₑ and V_{negative}.

12. The computerized apparatus of claim 11, wherein said step of determining the discrepancy relation by the processor comprises: determining an expected range of values around T_{expected} based on Pₚₒₛᵢₜᵢᵥₑ, P_{negative}, Vₚₒₛᵢₜᵢᵥₑ and V_{negative}; and wherein the discrepancy relation indicates discrepancy if Tₐᵤₜₒ is not within the expected range of values.

13. The computerized apparatus of claim 12, wherein the processor is further adapted to determine the expected range as a range between about (Pₚₒₛᵢₜᵢᵥₑ−Vₚₒₛᵢₜᵢᵥₑ)*T_{actual}+(P_{negative}−N_{negative})*(1−T_{actual}) and between about (Pₚₒₛᵢₜᵢᵥₑ+Vₚₒₛᵢₜᵢᵥₑ)*T_{actual}+(P_{negative}+V_{negative})*(1−T_{actual}).

14. The computerized apparatus of claim 10, wherein the reference diagnostic tool is configured to process all data available to the one or more healthcare professionals when performing said automatic determination.

15. The computerized apparatus of claim 14, wherein the data includes at least one of: diagnostic imaging; and clinical information.

16. A computer program product comprising a computer readable storage medium retaining program instructions, which program instructions when read by a processor, cause the processor to perform a method comprising:
obtaining a benchmark of cases of one or more healthcare professionals, wherein each case is associated with a patient, wherein the one or more healthcare professionals diagnosed each of which cases to determine whether a procedure is required;
determining a percentage T_{actual} of cases in the benchmark diagnosed by the one or more healthcare professionals as requiring the procedure;
determining a percentage T_{expected} of cases in the benchmark expected to be diagnosed by a reference diagnostic tool as requiring the procedure, wherein the reference diagnostic tool is configured to automatically determine whether the procedure is required, wherein the reference diagnostic tool has a probability Pₚₒₛᵢₜᵢᵥₑ of correctly diagnosing that the procedure is required, wherein the reference diagnostic tool has a probability P_{negative} of correctly diagnosing that the procedure is not required, wherein the percentage T_{expected} is determined based on Pₚₒₛᵢₜᵢᵥₑ, P_{negative}, and T_{actual};
utilizing the reference diagnostic tool to automatically diagnose for each case of the benchmark whether the procedure is required;
determining a percentage Tₐᵤₜₒ of cases in the benchmark diagnosed by the reference diagnostic tool as requiring the procedure;
determining a discrepancy relation between T_{expected} and Tₐᵤₜₒ; and, in response to the discrepancy relation indicating a discrepancy, providing an alert to an entity supervising the one or more healthcare professionals.
